(19) United States
(12) Patent Application Publication
(10) Pub. No.: US 2006/0166080 A1
(43) Pub. Date: Jul. 27, 2006

(54) Electrical power generator

(76) Inventor: Iradj Hessabi, Henderson, NV (US)

Correspondence Address: LEONARD WEISS, 871 CORONADO CTR. DR, SUITE 200, HENDERSON, NV, 89052, US

(21) Appl. No.: 11/044,878

(22) Filed: Jan. 26, 2005

(51) Int. Cl. H01M 2/36; H01M 2/38

(52) U.S. Cl. 429/88; 429/83; 429/71; 429/72

(57) ABSTRACT

A power generator includes a plurality of chambers, each of which has therein a positive electrode and a negative electrode. Each of the chambers has an entry port that is connected to a source of water through a timer valve. The water is periodically provided through the timer valve to the entry ports. The chambers additionally have en exit port that opens in response to pressure of the water from the timer valve. Water from the exit ports passes from the power source.

### BACKGROUND OF THE INVENTION

1. Field of Invention

The present invention relates generally to a source of electrical energy and, more specifically, to a direct current power source.

2. Description of the Prior Art

Batteries are the most commonly used electrical power source. They consist of cells in which chemical energy is converted into electrical energy. Each cell is a container having therein a negative electrode, a positive electrode, an electrolyte solution and electrode separators.

The negative electrode is in what is referred to as a reduced state whereas the positive electrode is in what is referred to as an oxidized state. When the cell is operating, the negative electrode yields electrons through an external circuit to the positive electrode whereby the negative electrode is oxidized and the positive electrode is reduced. The electrons are carried through the cell by ions of the electrolyte solution.

Two types of batteries are known, namely a primary battery and a secondary battery. In the primary battery, the oxidation and reduction cannot be efficiently reversed. This is not the case for the secondary battery, however, which are often referred to as a storage battery because of the reversibility.

The primary battery has a limited useful life; it is discarded upon depletion of its stored energy. The primary battery is not easily recyclable; it contributes to environmental pollution. The secondary cell has a longer useful life because of the reversibility of the oxidation and reduction, but they are heavy and utilize strong acids thereby making their disposal an environmental pollution problem.

Accordingly, there is a need for a direct current power source that has a long useful life and does not contribute to environmental pollution.

### SUMMARY OF THE INVENTION

According to the present invention, a direct current power source includes a plurality of chambers made from an electrically non-conductive material. The chambers are adapted to contain a liquid medium. A positive electrode and a negative electrode is disposed within each chamber, with the negative electrode having a greater electromotive force than the positive electrode. Periodically, fresh liquid is pumped into the chambers to refresh the liquid medium.

Other objects, features and advantages of the invention should be apparent from the following description of a preferred embodiment as illustrated in the accompanying drawing.

### BRIEF DESCRIPTION OF THE DRAWING

FIG. 1 is a perspective view of a preferred embodiment of the present invention with parts broken away;

FIG. 2 is a showing of a row of cells in the embodiment of FIG. 1 connected to a source of water; and

FIG. 3 is a showing of an entry port in a chamber in the embodiment of FIG. 1.

### DESCRIPTION OF THE PREFERRED EMBODIMENT

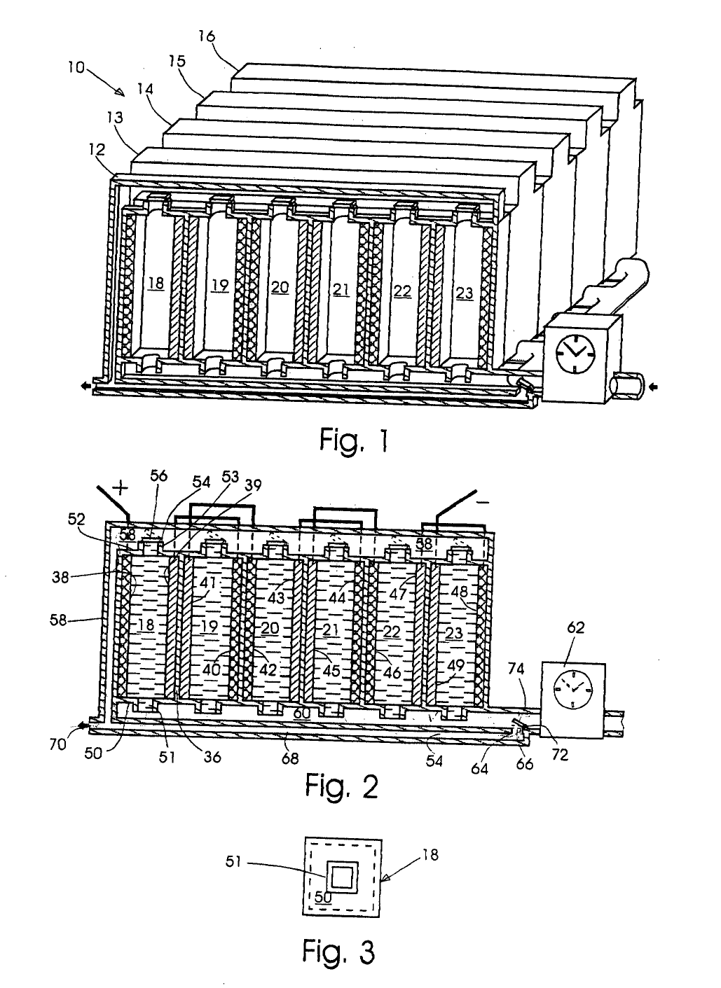

As shown in FIG. 1, a DC power source 10 is comprised of rows 12-16 of chambers. The row 12 includes chambers 18-23 that are similar to each other.

Similar to the batteries of the prior art, current capability of an arrangement of chambers is increased by connecting in parallel similar groups of chambers. Accordingly, an enhanced flexibility is provided by a large number of small chambers. Electrodes of the chambers may be connected in any of a multiplicity of configurations to meet the needs of a user.

As shown in FIG. 2, exemplary of chambers of the rows 13-16, the chamber 18 has plastic walls 34, 36 that are substantially electrically non-conductive. Within the chamber 18 are a copper electrode 38 and a zinc electrode 39 immersed in a liquid medium. In this embodiment, the liquid medium is tap water.

The copper electrode 38 and zinc electrode 39 are positive and negative, respectively, The copper electrode 38 has a positive electromotive force. The zinc electrode 39 has a negative electromotive force. The negative electromotive force is greater than the positive electromotive force.

In this embodiment, the chamber 18 has cross section dimensions of 5 millimeters×5 millimeters and a length of 20 millimeters. Dimensions of the electrodes 38, 39 are 1 millimeter×5 millimeters×20 millimeters.

Within the chamber 19-23 are copper electrodes 40, 42, 44, 46, 48, respectively. Additionally, within the chambers 19-23 are zinc electrodes 41, 43, 45, 47, 49, respectively. As an example of how chambers may be interconnected, on the exterior of the chambers 18-23, the electrodes 41, 43, 45,47, 49 are respectively connected to the electrodes 40, 42, 44, 46, 48 whereby the chambers 18-23 are connected in series. The series combination provides 4.5 volts with a current capability of 2 milliamperes between the electrodes 38, 49.

As shown in FIG. 3, a bottom 50 of the chamber 18 is connected to an entry port 51 of the chamber 18. The port 51 provides a passageway between the exterior of the chamber 18 and its interior. Similarly, a top 52 of the chamber 18 is connected to an exit port 53 (FIG. 2) of the cell 18. The port 53 is between the interior of the chamber 18 and a passageway 58. Ports, similar to the port 53 are between the chambers 19-23 and the passageway 58.

A hinge 54 has two sides that are rotatable with respect to each other. One side of the hinge 54 is connected to the port 53. The other side of the hinge 54 is connected to a panel 56. Hinges, such as the hinge 54, are well known in the art.

Because the sides of the hinge 54 are rotatable with respect to each other, the panel 56 is moveable to cover the port 53 and thereby provides an air tight separation of the port 53 from the passageway 58. Preferably, the hinge 54 is spring loaded to maintain the air tight separation in the absence of pressure provided by water in the chamber 18. Air tight separation of exit ports of the chambers 19-23 from the passageway 58 are similarly provided.

Although the passageway through the port 51 is unobstructed, it is small. Water does not flow from the chamber 18 through the port 51 when air cannot flow through the port 53 for the same reason that liquid does not flow from a hypodermic needle.

Entry ports of the chambers 19-23 and the port 51 are all connected together through a passageway 60 that is connected to an output of a timer valve 62. An input of the valve 62 is connected to a source of tap water (not shown).

Periodically, the valve 62 opens for a predetermined time interval. As explained hereinafter, opening the valve 62 causes a flow of water into the chambers of the rows 12-16. The flow of water into the chambers of the rows 12-16 flushes out any minerals that may have accumulated therein.

A wall 64 of the passageway 60 has a port 66 that connects the passageway 60 to a passageway 68. The passageway 68 is connected to an exit port 70 of the power source 10.

The port 66 is connected to one side of a hinge 72 that is similar to the hinge 54. A panel 74 is connected to the other side of the hinge 72. Because the sides of the hinge 72 are rotatable with respect to each other, the panel 74 is moveable to cover the port 66, thereby providing a watertight separation between the passageways 60, 68.

The hinge 72 is spring loaded to prevent the covering of the port 66 in the absence of pressure provided by water from the valve 62. In the absence of the watertight separation, water within the passageway 60 flows through the port 66 into the passageway 68 and passes from the power source 10 through the port 70.

When the valve 62 opens, a flow of water therefrom causes the panel 74 to cover the port 66. The flow of water creates a pressure within the chamber 18 that causes the panel 56 and to rotate in a direction that removes the separation of the port 53 from the passageway 58. Separation of the exit ports of the chambers 19-23 from the passageway 58 is similarly removed.

The water pressure additionally causes a flow of fresh water from the valve 62 through the passageway 60 into the chambers 18-23. The flow of fresh water into the chambers 18-23 causes a flow of replaced water therefrom through the port 70 via the passageway 58.

After the predetermined time interval, water no longer flows through the valve 62 and the panel 74 does not provide the watertight separation between the passageways 60, 68. When there is no watertight separation, water within the passageway 60 flows from power source 10 through the port 70 via the port 66 and the passageway 68.

While the invention has been particularly shown and described with reference to a preferred embodiment, it should be understood by those skilled in the art that changes in form and detail may be made therein without departing from the spirit and scope of the invention.

I claim:

1. A DC power source comprising:
a plurality of chambers having walls that are electrically non-conductive;
a liquid within said chambers;
an electrode pair disposed within each of said chambers with no structural member therebetween, one electrode of each pair having a positive electromotive force and the other having a negative electromotive force; and
means for refreshing said liquid.

2. The power source of claim 1 wherein one of said chambers has an entry port for said liquid at one end and an exit port for said liquid at an opposite end, said means for refreshing additionally comprising a valve that is connected to said entry port, said valve being operable to provide a passageway for said liquid through said entry port.

3. The power source of claim 2 additionally comprising means for providing an air tight separation between said exit port and an exterior of said chamber, in an absence of fluid pressure caused by said flow of liquid.

4. The power source of claim 3 wherein said means for providing comprises:
a panel;
a hinge that has two sides that are rotatable with respect to each other one side of said hinge being connected to said panel and the other side being connected to said exit port to cause said panel to be moveable to cover said exit port and provide said air tight separation.

5. The power source of claim 3 additionally comprising means for discharging from said power source liquid at the exterior of said chamber.

6. The power source of claim 1 wherein said liquid is tap water.

7. The power source of claim 1 wherein said electrodes having said positive and negative electromotive forces are copper and zinc, respectively
